(19) United States
(12) Patent Application Publication
(10) Pub. No.: US 2026/0291661 A1
(43) Pub. Date: Sep. 24, 2026

(54) CONFIGURING FREQUENCY HOPS WITHIN A REFERENCE SIGNAL TRANSMISSION

(71) Applicant: QUALCOMM Incorporated, San Diego, CA (US)

(72) Inventors: Alexandros MANOLAKOS, Athens (GR); Jae Ho RYU, San Diego, CA (US); Sony AKKARAKARAN, Poway, CA (US)

(21) Appl. No.: 19/469,897

(22) PCT Filed: May 9, 2024
(86) PCT No.: PCT/US2024/028636

§ 371 Date: Sep. 26, 2025

(30) Foreign Application Priority Data
May 15, 2023 (GR) 20230100393

(51) Int. Cl. H04L 5/00; H04W 64/00

(52) U.S. Cl. CPC H04L 5/0012; H04W 64/00

(57) ABSTRACT

An example apparatus for wireless communication by user equipment (UE), the apparatus including one or more transceivers, one or more memories, and one or more processors communicatively coupled with the one or more transceivers and the one or more memories, wherein the one or more processors are configured to: receive a configuration for a transmission of a reference signal for positioning, the reference signal comprising a plurality of frequency hops, determine an available opportunity for a frequency hop of the plurality of frequency hops within the reference signal, wherein the available opportunity corresponds to a plurality of consecutive orthogonal frequency division multiplexing (OFDM) symbols within which the UE may transmit the frequency hop, and transmit the plurality of frequency hops within the available opportunity of the reference signal.

### RELATED APPLICATIONS

This application claims the benefit of Greek application No. 20230100393, filed May 15, 2023, entitled “CONFIGURING FREQUENCY HOPS WITHIN A REFERENCE SIGNAL TRANSMISSION”, which is assigned to the assignee hereof, and incorporated herein in its entirety by reference.

### TECHNICAL FIELD

This disclosure relates generally to wireless communication, and more specifically, to reference signal configuration and use.

### DESCRIPTION OF THE RELATED TECHNOLOGY

Wireless communication systems have developed through various generations, including a first-generation analog wireless phone service (1G), a second-generation (2G) digital wireless phone service (including interim 2.5G networks), a third generation (3G) high speed data, Internet-capable wireless service and a fourth-generation (4G) service (e.g., LTE or WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large wireless deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The systems, methods, and devices of this disclosure each have several innovative aspects, no single one of which is solely responsible for the desirable attributes disclosed herein.

One innovative aspect of the subject matter described in this disclosure can be implemented as an apparatus for wireless communication by user equipment (UE), the apparatus including one or more transceivers, one or more memories, and one or more processors communicatively coupled with the one or more transceivers and the one or more memories, wherein the one or more processors are configured to: receive a configuration for a transmission of a reference signal for positioning, the reference signal comprising a plurality of frequency hops, determine an available opportunity for a frequency hop of the plurality of frequency hops within the reference signal, wherein the available opportunity corresponds to a plurality of consecutive orthogonal frequency division multiplexing (OFDM) symbols within which the UE may transmit the frequency hop, and transmit the plurality of frequency hops within the available opportunity of the reference signal.

Another innovative aspect of the subject matter described in this disclosure can be implemented as an apparatus for wireless communication by user equipment (UE), the apparatus including one or more transceivers, one or more memories, and one or more processors communicatively coupled with the one or more transceivers and the one or more memories, wherein the one or more processors are configured to: determine a number of frequency hops to sound a bandwidth of a reference signal based on at least two of a total number of orthogonal frequency division multiplexing (OFDM) symbols of a reference signal resource, a UE capability for a number of symbols gap (e.g., time-domain gap) included between a plurality of frequency hops, and a number of OFDM symbols within each of the plurality of frequency hops, and transmit the reference signal with the determined number of frequency hops.

Another innovative aspect of the subject matter described in this disclosure can be implemented as a method of configuring a reference signal transmission, the method including receiving at user equipment (UE) a configuration for a transmission of a reference signal for positioning, the reference signal comprising a plurality of frequency hops, determining an available opportunity for a frequency hop of the plurality of frequency hops within the reference signal, wherein the available opportunity corresponds to a plurality of consecutive orthogonal frequency division multiplexing (OFDM) symbols within which the UE may transmit the frequency hop, and transmitting the plurality of frequency hops within the available opportunity of the reference signal.

Another innovative aspect of the subject matter described in this disclosure can be implemented as a method of configuring a reference signal transmission, the method including determining a number of frequency hops to sound a bandwidth of a reference signal based on at least two of a total number of orthogonal frequency division multiplexing (OFDM) symbols of a reference signal resource, a UE capability for a number of symbols gap included between a plurality of frequency hops, and a number of OFDM symbols within each of the plurality of frequency hops, and transmitting the reference signal with the determined number of frequency hops.

Another innovative aspect of the subject matter described in this disclosure can be implemented as a wireless communication device comprising a means for receiving at user equipment (UE) a configuration for a transmission of a reference signal for positioning, the reference signal comprising a plurality of frequency hops, a means for determining an available opportunity for a frequency hop of the plurality of frequency hops within the reference signal, wherein the available opportunity corresponds to a plurality of consecutive orthogonal frequency division multiplexing (OFDM) symbols within which the UE may transmit the frequency hop, and a means for transmitting the plurality of frequency hops within the available opportunity of the reference signal.

Another innovative aspect of the subject matter described in this disclosure can be implemented as a wireless communication device comprising wireless communication device comprising a means for determining a number of frequency hops to sound a bandwidth of a reference signal based on at least two of a total number of orthogonal frequency division multiplexing (OFDM) symbols of a reference signal resource, a UE capability for a number of symbols gap included between a plurality of frequency hops, and a number of OFDM symbols within each of the plurality of frequency hops, and a means for transmitting the reference signal with the determined number of frequency hops.

Another innovative aspect of the subject matter described in this disclosure can be implemented as a computer-readable medium storing computer executable code for wireless communications, comprising code to receive at user equipment (UE) a configuration for a transmission of a reference signal for positioning, the reference signal comprising a plurality of frequency hops, determine an available opportunity for a frequency hop of the plurality of frequency hops within the reference signal, wherein the available opportunity corresponds to a plurality of consecutive orthogonal frequency division multiplexing (OFDM) symbols within which the UE may transmit the frequency hop, and transmit the plurality of frequency hops within the available opportunity of the reference signal.

Another innovative aspect of the subject matter described in this disclosure can be implemented as a computer-readable medium storing computer executable code for wireless communications, comprising code to determine a number of frequency hops to sound a bandwidth of a reference signal based on at least two of: a total number of orthogonal frequency division multiplexing (OFDM) symbols of a reference signal resource, a UE capability for a number of symbols gap included between a plurality of frequency hops, and a number of OFDM symbols within each of the plurality of frequency hops, and transmit the reference signal with the determined number of frequency hops.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of how beamforming may be performed, according to some embodiments.

FIG. 4 is a diagram showing an example of a frame structure for NR and associated terminology.

FIG. 5 is a diagram showing an example of a radio frame sequence with Positioning Reference Signal (PRS) positioning occasions.

FIG. 6 is a diagram showing example combination (comb) structures, illustrating how RF signals may utilize different sets of resource elements according to some embodiments.

FIG. 7 is a diagram of a hierarchical structure of how PRS resources and PRS resource sets may be used by different Transmission Reception Point (TRPs) of a given position frequency layer (PFL), as defined in 5G NR.

FIG. 8 is a time diagram illustrating slot usage of a resource set according to an embodiment.

FIG. 9 is a flow diagram according to a particular embodiment.

FIG. 10 is a flow diagram according to another particular embodiment.

FIG. 11 is a flow diagram according to a further particular embodiment.

FIG. 12 is a block diagram of an embodiment of a UE, which can be utilized in embodiments as described herein.

FIG. 13 is a block diagram of an embodiment of a computer system, which can be utilized in embodiments as described herein.

FIG. 14 is a block diagram of an embodiment of a base station, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to managing reference signal transmissions. Some aspects more specifically relate to configuring reference signals for positioning. In some examples, an UE may receive a configuration for a transmission of a reference signal for positioning, and the reference signal may include a plurality of frequency hops. The UE may determine an available opportunity for a frequency hop of the plurality of frequency hops within the reference signal, where the available opportunity corresponds to a plurality of consecutive OFDM symbols within which the UE may transmit the frequency hop. The UE may transmit the plurality of frequency hops within the available opportunity of the reference signal.

Particular aspects of the subject matter described in this disclosure can be implemented to realize one or more of the following potential advantages. In some examples, by determining an available opportunity for a frequency hop within the reference signal, the described techniques can be used to increase the bandwidth available for positioning. Some systems, such as reduced capability (redcap) systems, operate using a limited bandwidth. The bandwidth limitations may limit the precision of positioning techniques. An implementation may enable improved positioning by positioning frequency hops such that more bandwidth is available for precise positioning.

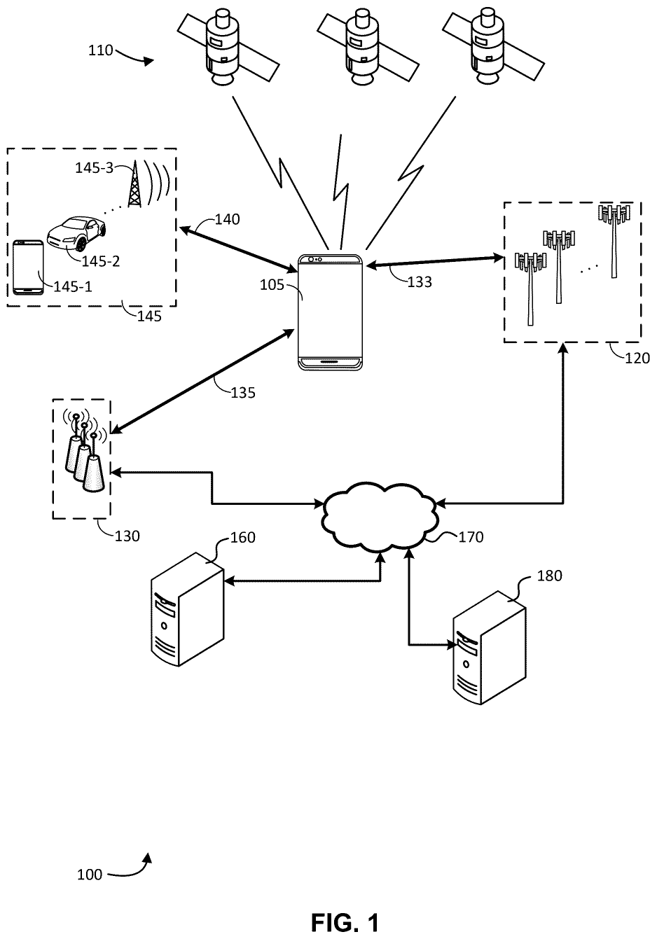

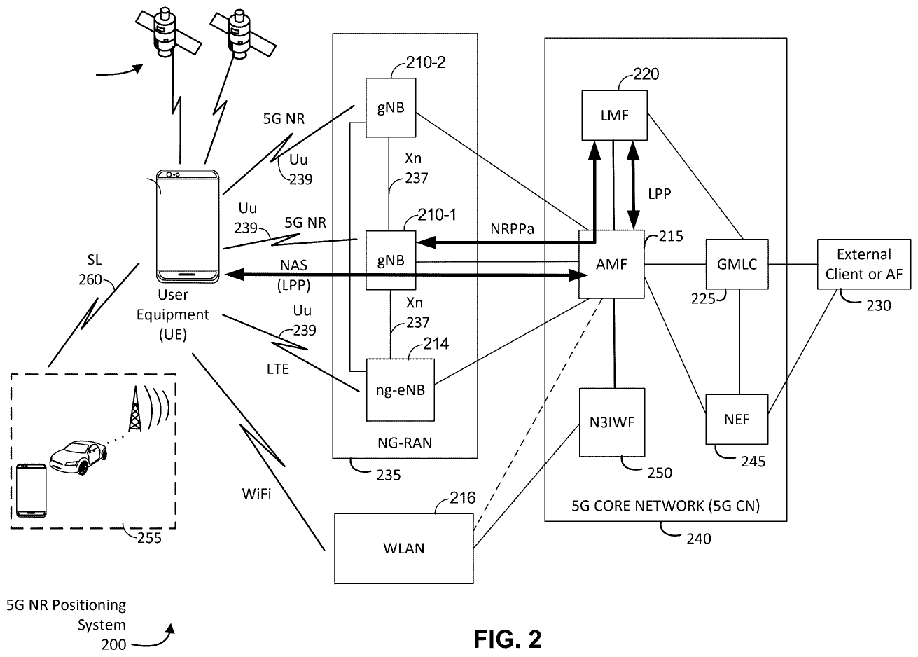

FIG. 1 is a simplified illustration of a positioning system 100 in which a UE 105, location server 160, and/or other components of the positioning system 100 can use the techniques provided herein for configuring frequency hops within a reference signal transmission, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g., with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments, NTN nodes may include non-terrestrial vehicles such as airplanes, balloons, drones, etc., which may be used in addition to or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with the known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile devices capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g., to assist direction finding or navigation for a user of UE 105 or to assist another user (e.g., associated with external client 180) in locating UE 105. A “location” is also referred to herein as a “location estimate,” “estimated location,” “location,” “position,” “position estimate,” “position fix,” “estimated position,” “location fix,” or “fix.” The process of determining a location may be referred to as “positioning,” “position determination,” “location determination,” or the like. A location of UE 105 may comprise an absolute location of UE 105 (e.g., latitude and longitude and possibly altitude) or a relative location of UE 105 (e.g., a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates that may be absolute (e.g., latitude, longitude, and optionally altitude), relative (e.g., relative to some known absolute location), or local (e.g., X, Y, and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building, etc. A location may further include an uncertainty or error indication, such as a horizontal and possibly vertical distance by which the location is expected to be in error or an indication of an area or volume (e.g., a circle or ellipse) within which UE 105 is expected to be located with some level of confidence (e.g., 95% confidence).

The external client 180 may be a web server or remote application that may have some association with UE 105 (e.g., may be accessed by a user of UE 105) or may be a server, application, or computer system providing a location service to some other user or users which may include obtaining and providing the location of UE 105 (e.g., to enable a service such as a friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105 and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g., GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections, which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216, which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors, and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building, such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location, which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g., for latitude, longitude, and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly, as shown in FIG. 2, or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g., gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next-generation evolved Node B, also referred to as an ng-eNB, 214. Ng-eNB 214 may be connected to one or more gNBs 210 in NG-RAN 235—e.g., directly or indirectly via other gNBs 210 and/or other ng-eNBs. An ng-eNB 214 may provide LTE wireless access and/or evolved LTE (eLTE) wireless access to UE 105. Some gNBs 210 (e.g., gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216, which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT, such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g., AMF 215, as shown by the dashed line in FIG. 2) and not via N3IWF 250. For example, a direct connection of WLAN 216 to 5GCN 240 may occur if WLAN 216 is a trusted WLAN for 5GCN 240 and may be enabled using a Trusted WLAN Interworking Function (TWIF) (not shown in FIG. 2), which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE-assisted/UE-based and/or network-based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE-assisted and/or UE-based position methods such as A-GNSS, RTK, TDOA, multi-cell RTT, AoD, and/or ECID. The NRPPa protocol may be used to support positioning of UE 105 using network-based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220 via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220 via the AMF 215 to support network-based positioning of UE 105 based on location-related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE-based positioning of UE 105 by LMF 220, described in more detail hereafter.

Positioning of the UE 205 in a 5G NR positioning system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals are sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally, or alternatively, the UE 205 and the one or more other UEs 255 may coordinate a positioning session between themselves without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods, location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE-assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL-based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, which is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

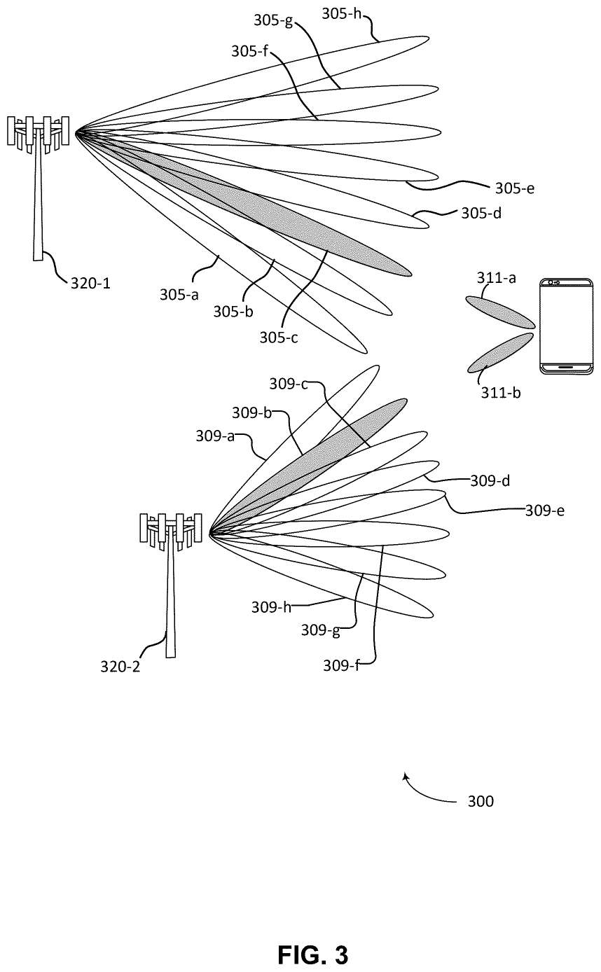

FIG. 3 depicts a simplified environment 300 including two base stations 320-1 and 320-2 (e.g., which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. Such directional beams are used in 5G NR wireless communication networks. Each directional beam may have a beam width centered in a different direction, enabling different beams of a base station 320 to correspond with different areas within a coverage area for the base station 320.

Different modes of operation may enable base stations 320-1 and 320-2 to use a larger or smaller number of beams. For example, in a first mode of operation, a base station 320 may use 16 beams, and beam may have a relatively wide beam width. In a second mode of operation, a base station 320 may use 64 beams, in which case each beam may have a relatively narrow beam width. Depending on the capabilities of a base station 320, the base station may use any number of beams the base station 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 320 may use beam sweeping. Beam sweeping is a process in which the base station 320 may send an RF signal in different directions using different respective beams, often in succession, effectively “sweeping” across a coverage area. For example, a base station 320 may sweep across 120 or 360 degrees in an azimuth direction for each beam sweep, which may be periodically repeated. Each direction beam can include an RF reference signal (e.g., a PRS resource), where base station 320-1 produces a set of RF reference signals that includes Tx beams 305-a, 305-b, 305-c, 305-d, 305-e, 305-f, 305-g, and 305-h, and the base station 320-2 produces a set of RF reference signals that includes Tx beams 309-a, 309-b, 309-c, 309-d, 309-e, 309-f, 309-g, and 309-h. As noted, because UE 105 may also include an antenna array, it can receive RF reference signals transmitted by base stations 320-1 and 320-2 using beamforming to form respective receive beams (Rx beams) 311-a and 311-b. Beamforming in this manner (by base stations 320 and optionally by UEs 105) can be used to make communications more efficient. They can also be used for other purposes, including taking measurements for position determination (e.g., AoD and AoA measurements).

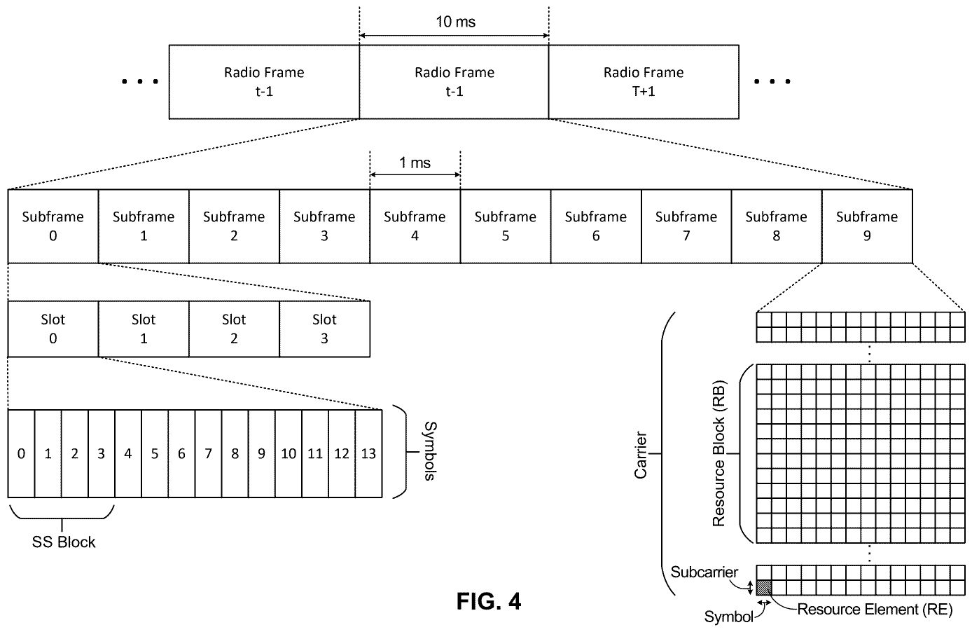

FIG. 4 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub-slot structure (e.g., 2, 3, or 4 symbols). Additionally shown in FIG. 4 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two-symbol Physical Broadcast Channel (PBCH). The SS block can be transmitted in a fixed slot location, such as the symbols 0-3 as shown in FIG. 4. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

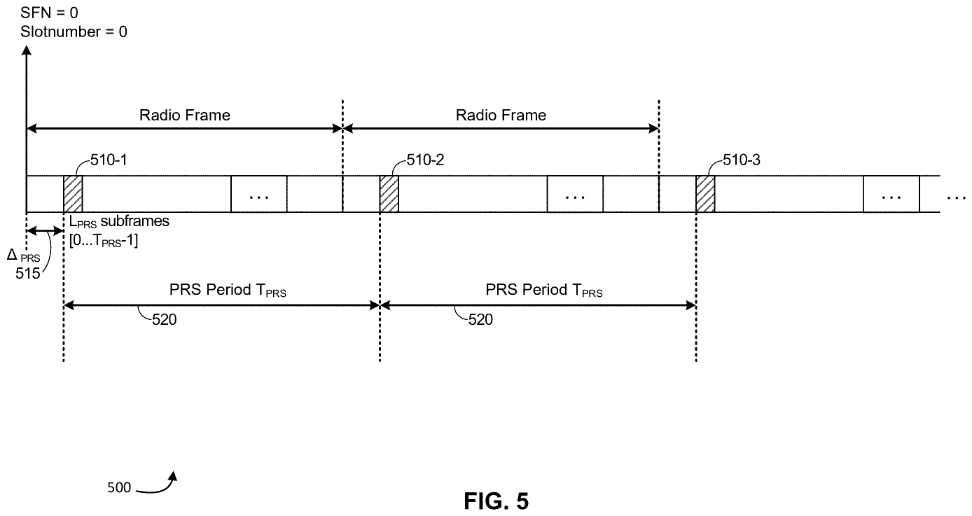

FIG. 5 is a diagram showing an example of a radio frame sequence 500 with PRS positioning occasions. A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance, a “positioning occasion,” “a positioning instance,” or simply an “occasion” or “instance.” Subframe sequence 500 may be applicable to broadcast of PRS signals (DL-PRS signals) from base stations 120 in positioning system 100. The radio frame sequence 500 may be used in 5G NR (e.g., in 5G NR positioning system 200) and/or in LTE. Similar to FIG. 4, time is represented horizontally (e.g., on an X axis) in FIG. 5, with time increasing from left to right. Frequency is represented vertically (e.g., on a Y axis) with frequency increasing (or decreasing) from bottom to top.

FIG. 5 shows how PRS positioning occasions 510-1, 510-2, and 510-3 (collectively and generically referred to herein as positioning occasions 510) are determined by a System Frame Number (SFN), a cell-specific subframe offset (APRS) 515, a length or span of LPRS subframes, and the PRS Periodicity (T_{PRS}) 520. The cell-specific PRS subframe configuration may be defined by a “PRS Configuration Index,” IPRS, which is included in assistance data (e.g., TDOA assistance data) and may be defined by governing 3GPP standards. The cell-specific subframe offset (APRS) 515 may be defined in terms of the number of subframes transmitted starting from System Frame Number (SFN) 0 to the start of the first (subsequent) PRS positioning occasion.

A PRS may be transmitted by wireless nodes (e.g., base stations 120) after appropriate configuration (e.g., by an Operations and Maintenance (O&M) server). A PRS may be transmitted in special positioning subframes or slots that are grouped into positioning occasions 510. For example, a PRS positioning occasion 510-1 can comprise a number N_{PRS} of consecutive positioning subframes where the number N_{PRS} may be between 1 and 160 (e.g., may include the values 1, 2, 4, and 6 as well as other values). PRS occasions 510 may be grouped into one or more PRS occasion groups. As noted, PRS positioning occasions 510 may occur periodically at intervals, denoted by a number T_{PRS}, of millisecond (or subframe) intervals where T_{PRS} may equal 5, 10, 20, 40, 80, 160, 320, 640, or 1280 (or any other appropriate value). In some embodiments, T_{PRS} may be measured in terms of the number of subframes between the start of consecutive positioning occasions.

In some embodiments, when a UE 105 receives a PRS configuration index IPRS in the assistance data for a particular cell (e.g., base station), the UE 105 may determine the PRS periodicity T_{PRS} 520 and cell-specific subframe offset (APRS) 515 using stored indexed data. The UE 105 may then determine the radio frame, subframe, and slot when a PRS is scheduled in the cell. The assistance data may be determined by, for example, a location server (e.g., location server 160 in FIG. 1 and/or LMF 220 in FIG. 2), and includes assistance data for a reference cell, and a number of neighbor cells supported by various wireless nodes.

Typically, PRS occasions from all cells in a network that use the same frequency are aligned in time and may have a fixed known time offset (e.g., cell-specific subframe offset (APRS) 515) relative to other cells in the network that use a different frequency. In SFN-synchronous networks all wireless nodes (e.g., base stations 120) may be aligned on both frame boundary and system frame number. Therefore, in SFN-synchronous networks all cells supported by the various wireless nodes may use the same PRS configuration index for any particular frequency of PRS transmission. On the other hand, in SFN-asynchronous networks, the various wireless nodes may be aligned on a frame boundary but not system frame number. Thus, in SFN-asynchronous networks the PRS configuration index for each cell may be configured separately by the network so that PRS occasions align in time. A UE 105 may determine the timing of the PRS occasions 510 of the reference and neighbor cells for TDOA positioning if the UE 105 can obtain the cell timing (e.g., SFN or Frame Number) of at least one of the cells, e.g., the reference cell or a serving cell. The timing of the other cells may then be derived by the UE 105 based, for example, on the assumption that PRS occasions from different cells overlap.

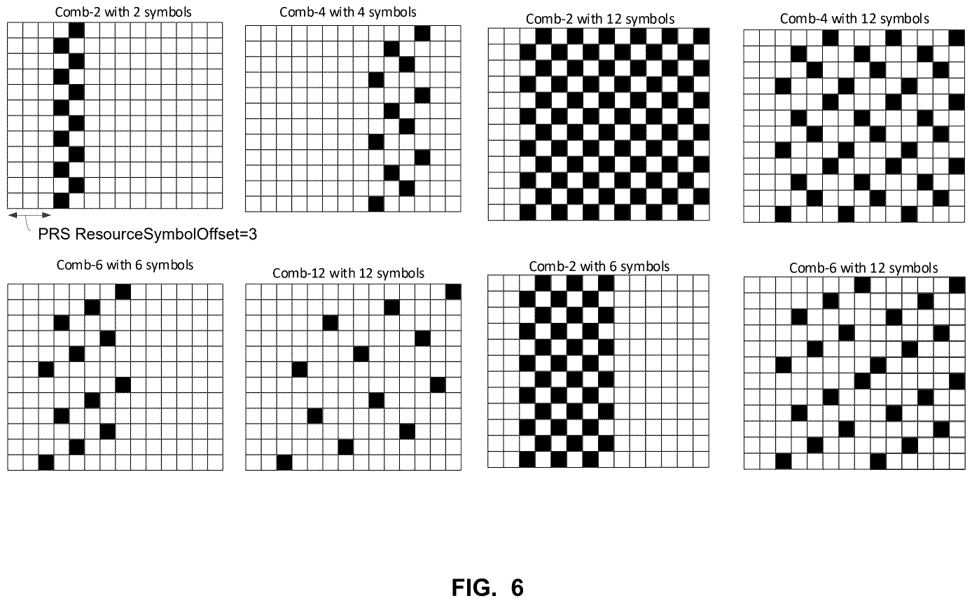

With reference to the frame structure in FIG. 4, a collection of REs that are used for transmission of PRS is referred to as a “PRS resource.” The collection of resource elements can span multiple RBs in the frequency domain and one or more consecutive symbols within a slot in the time domain, inside which pseudo-random Quadrature Phase Shift Keying (QPSK) sequences are transmitted from an antenna port of a TRP. In a given OFDM symbol in the time domain, a PRS resource occupies consecutive RBs in the frequency domain. The transmission of a PRS resource within a given RB has a particular combination, or “comb,” size. (Comb size also may be referred to as the “comb density.”) A comb size “N” represents the subcarrier spacing (or frequency/tone spacing) within each symbol of a PRS resource configuration, where the configuration uses every Nth subcarrier of certain symbols of an RB. For example, for comb-4, for each of the four symbols of the PRS resource configuration, REs corresponding to every fourth subcarrier (e.g., subcarriers 0, 4, 8) are used to transmit PRS of the PRS resource. Comb sizes of comb-2, comb-4, comb-6, and comb-12, for example, may be used in PRS. Examples of different comb sizes using with different numbers of symbols are provided in FIG. 6.

A “PRS resource set” comprises a group of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a cell ID). A “PRS resource repetition” is a repetition of a PRS resource during a PRS occasion/instance. The number of repetitions of a PRS resource may be defined by a “repetition factor” for the PRS resource. In addition, the PRS resources in a PRS resource set may have the same periodicity, a common muting pattern configuration, and the same repetition factor across slots. The periodicity may have a length selected from 2^{m}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set may be associated with a single beam (and/or beam ID) transmitted from a single TRP (where a TRP may transmit one or more beams). That is, each PRS resource of a PRS resource set may be transmitted on a different beam, and as such, a PRS resource (or simply “resource”) can also be referred to as a “beam.” Note that this does not have any implications on whether the TRPs and the beams on which PRS are transmitted are known to the UE.

In the 5G NR positioning system 200 illustrated in FIG. 2, a TRP (gNB 210, ng-eNB 214, and/or WLAN 216) may transmit frames or other physical layer signaling sequences, supporting PRS signals (i.e., a DL-PRS) according to frame configurations as previously described, which may be measured and used for position determination of the UE 105. As noted, other types of wireless network nodes, including other UEs, may also be configured to transmit PRS signals configured in a manner similar to (or the same as) that described above. Because transmission of a PRS by a wireless network node may be directed to all UEs within radio range, the wireless network node may be considered to transmit (or broadcast) a PRS.

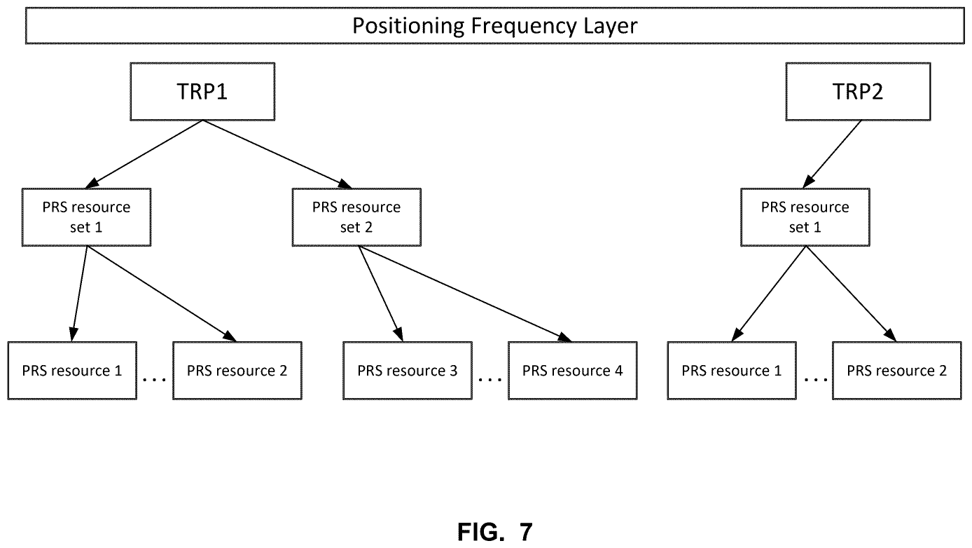

FIG. 7 is a diagram of a hierarchical structure of how PRS resources and PRS resource sets may be used by different TRPs of a given position frequency layer (PFL), as defined in 5G NR. With respect to a network (Uu) interface, a UE 105 can be configured with one or more DL-PRS resource sets from each of one or more TRPs. Each DL-PRS resource set includes K≥1 DL-PRS resource(s), which, as previously noted, may correspond to a Tx beam of the TRP. A DL-PRS PFL is defined as a collection of DL-PRS resource sets that have the same subcarrier spacing (SCS) and cyclic prefix (CP) type, the same value of DL-PRS bandwidth, the same center frequency, and the same value of comb size. In current iterations of the NR standard, a UE 105 can be configured with up to four DL-PRS PFLs.

NR has multiple frequency bands across different frequency ranges (e.g., Frequency Range 1 (FR1) and Frequency Range 2 (FR2)). PFLs may be on the same band or different bands. In some embodiments, they may even be in different frequency ranges. Additionally, as illustrated in FIG. 7, multiple TRPs (e.g., TRP1 and TR2) may be on the same PFL. Currently, under NR, each TRP can have up to two PRS resource sets, each with one or more PRS resources, as previously described.

Different PRS resource sets may have different periodicity. For example, one PRS resource set may be used for tracking and another PRS resource that could be used for acquisition. Additionally or alternatively, one PRS resource set may have more beams, and another may have fewer beams. Accordingly, different resource sets may be used by a wireless network for different purposes.

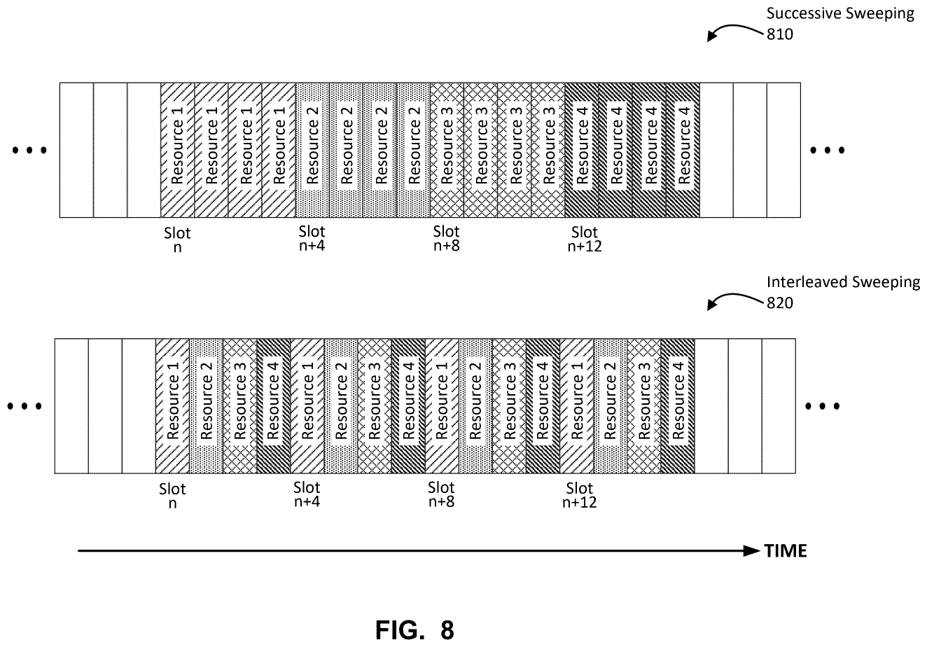

FIG. 8 is a time diagram illustrating two different options for slot usage of a resource set, according to an embodiment. Because each example repeats each resource four times, the resource set is said to have a repetition factor of four. Successive sweeping 810 comprises repeating a single resource (resource 1, resource 2, etc.) four times before proceeding to a subsequent resource. In this example, if each resource corresponds to a different beam of a TRP, the TRP repeats a beam for four slots in a row before moving to the next beam. Because each resource is repeated in successive slots (e.g., resource one is repeated in slots n, n+1, n+2, etc.), the time gap is said to be one slot. On the other hand, for interleaved sweeping 820, the TRP may move from one beam to the next for each subsequent slot, rotating through four beams for four rounds. Because each resource is repeated every four slots (e.g., resource 1 is repeated in slots n, n+4, n+8, etc.), the time gap is said to be one slot. Of course, embodiments are not so limited. Resource sets may comprise a different number of resources and/or repetitions. Moreover, as noted above, each TRP may have multiple resource sets, multiple TRPs may utilize a single FL, and a UE may be capable of taking measurements of PRS resources transmitted via multiple FLs.

Thus, to obtain PRS measurements from PRS signals sent by TRPs and/or UEs in a network, the UE can be configured to observe PRS resources during a period of time called a measurement period. That is, to determine a position of the UE using PRS signals, a UE and a location server (e.g., LMF 220 of FIG. 2) may initiate a location session in which the UE is given a period of time to observe PRS resources and report resulting PRS measurements to the location server. As described in more detail below, this measurement period may be determined based on the capabilities of the UE.

A UE can be configured to execute a measurement gap (MG) pattern to measure and process PRS resources during the measurement period. The UE can request a measurement gap from a serving TRP, for example, which can then provide the UE with the configuration (e.g., via Radio Resource Control (RRC) protocol).

As noted, a UE may be configured to execute an MG pattern to measure and process PRS resources of a PRS resource set outside an active DL bandwidth part (BWP) via which the UE sends and receives data with a serving TRP. To allow the network to configure the UE in a manner that accommodates the processing and buffering capabilities of the UE (which may be dynamic), the UE may provide to the network (e.g., a TRP or location server) capabilities related to PRS processing. The various parameters of the MG pattern can be configured based on these capabilities.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “k” relative to a reference cell “Ref,” may be given as (ToAₖ-ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

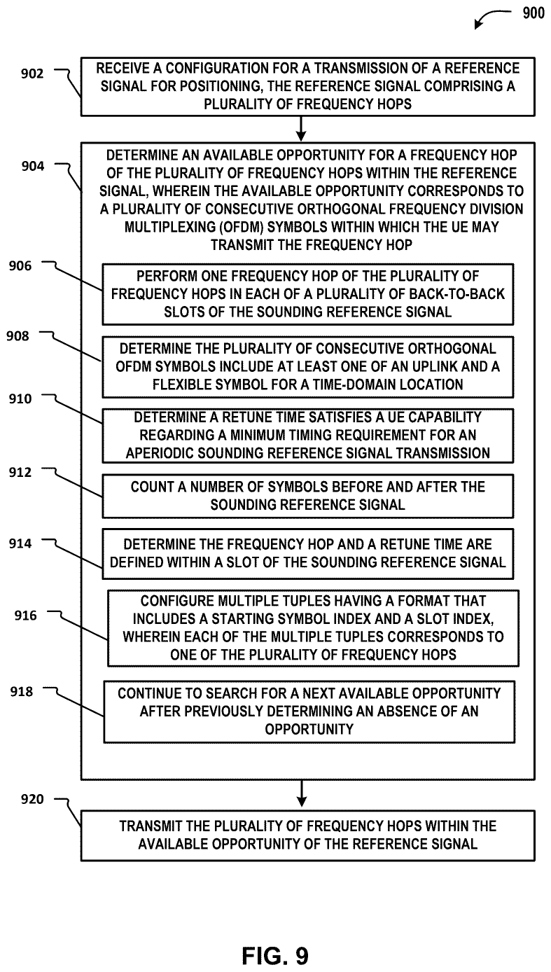

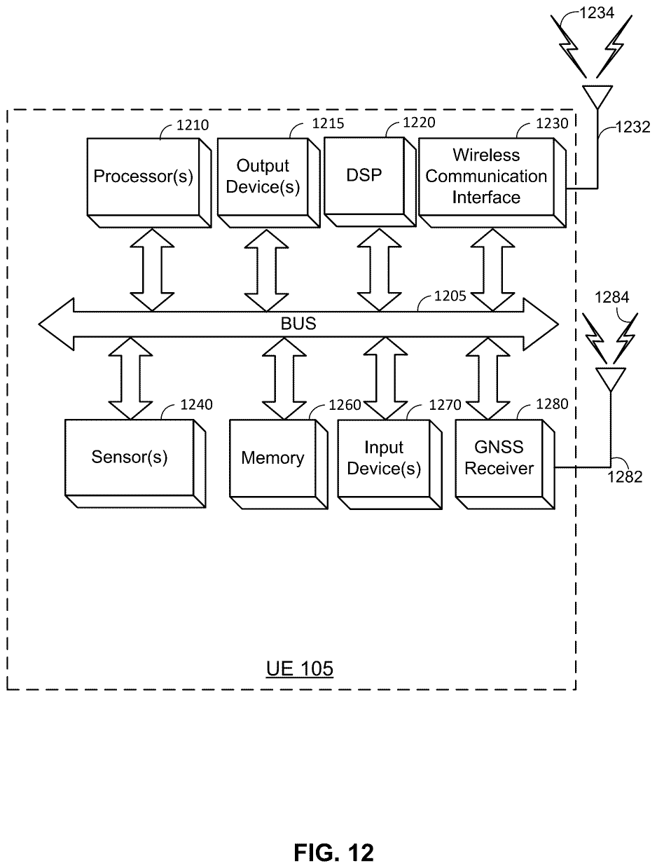

FIG. 9 is a flow diagram of a method 900 of determining an available opportunity for the transmission of the plurality of frequency hops, according to an embodiment. Means for performing the functionality illustrated in one or more of the blocks shown in FIG. 9 may be performed by hardware and/or software components to determine an available opportunity for the transmission of the plurality of frequency hops. Example components of an illustrative apparatus (e.g., a UE) are illustrated in FIG. 12, which is described in more detail below.

An implementation of the method 900 may use time domain transmission properties of an SRS resource for positioning frequency hops within intra-slot and back-to-back slot scenarios. An illustrative implementation may include reduced capability (redcap) UEs. The method 900 may use the SRS for positioning transmission frequency hopping is configured in a manner that includes using one frequency hop within one SRS for positioning resource. In another example, frequency hops may be distributed across resources, within one SRS for positioning a resource set. Still another implementation may apply across resource sets, with all resources in a set corresponding to the same frequency hop sub-bandwidth.

As described in more detail herein, the method 900 may include a UE receiving at block 902 a configuration for transmission of one or more frequency hops of an SRS for positioning.

Means for performing functionality at block 902 may comprise bus 1205, processor(s) 1210, wireless communication interface 1230, memory 1260, and/or other components of a UE, such as those as illustrated in FIG. 12 and described hereafter.

The UE may determine at block 904 available opportunities for transmission of the configured frequency hops. Available opportunities may correspond to a collection of consecutive OFDM symbols within which the UE may transmit one frequency hop of an RS according to some rules.

Means for performing functionality at block 904 may comprise bus 1205, processor(s) 1210, wireless communication interface 1230, memory 1260, and/or other components of a UE, such as those as illustrated in FIG. 12 and described hereafter.

At block 920, the UE may transmit the frequency hops within the available opportunities.

Means for performing functionality at block 920 may comprise bus 1205, processor(s) 1210, wireless communication interface 1230, memory 1260, and/or other components of a UE, such as those as illustrated in FIG. 12 and described hereafter.

In a particular implementation, the transmission frequency hopping is configured within one SRS for positioning resources. Determining factors may include potential collisions between other uplink and downlink signals and channels. To this end, UE capabilities may include an uplink time window where the UE is not expected to receive/transmit other signals/channels. In such a scenario, the UE may only be expected to transmit front haul SRS for positioning. The uplink time window may cause the UE to drop the transmission of other signals/channels and transmit the SRS for positioning.

In another implementation, additional collision rules between the uplink SRS involving frequency hopping and other uplink and downlink signals may apply. According to one option, UE of a wireless system may reuse an already existing single {Symbol-idx, slot-idx} in a configuration and have implicit rules of how these are being interpreted. For instance, the UE may be expected to do a first frequency hop on a configured slot index (startPosition-r16). The UE may perform up to X number of frequency hop(s) per slot, starting in the same slot when X=2. If the number of symbols-r16=1, then X=5. Each frequency hop at 906 may comprise the number of symbols-r16 (e.g., startPosition-r16) in each slot, for back-to-back slots (e.g., at 908), until all the frequency hops have been sounded at 920. For example, 5 slots may be used with X=1 frequency hop per slot. The pattern may repeat with a given periodicity. The symbols in between the frequency hops may be positioned according to a reported UE capability. In another or the same implementation, the symbols may be included according to an additional configuration that may be provided to the UE.

In an example where X=1, for a given symbol index and slot index, the UE may transmit 5 frequency hops, with each one starting at the symbol index of a corresponding slot, for 5 slots back-to-back, starting from slot with ID equals to the slot index. In an example, where X=2, the UE may transmit 5 frequency hops, with the first 2 being a slot with ID being slot index. As such, the first frequency hop may start in a symbol index and have Y symbols of the gap. The second frequency hop may start in symbol-idx+Y+1. The third and fourth frequency hops may be in the slot with ID slot-idx+1, such that the first frequency hop will start in symbol symbol-idx and have Y symbols of gap. The second frequency hop may start in symbol-idx+Y+1. The fifth frequency hop will be in the slot with ID slot-idx+2, such that the frequency hop may start in the symbol symbol-idx. X may be specified, configured separately, or be related to the duration of the resource. If nrofSymbols-r16=8 or 12, then X=1, if nrofSymbols-r16=4, then X=2.

In another implementation, the UE may initiate the first X frequency hop(s) in an indicated slot and then continue in later available slots (or generally “available frequency hop opportunities”). Available slot/hop opportunities may include an available frequency hop opportunity for transmission of a frequency hop of an SRS resource that corresponds at 908 to a consecutive set of OFDM symbols in a slot satisfying that there are uplink or flexible symbol(s) for the time-domain location(s) for all the symbols of the frequency hop, potentially together with any necessary retune time. The foregoing may satisfy UE's capability to meet the minimum timing requirement between triggering PDCCH and all the SRS resources in the resource set (e.g., assuming an aperiodic SRS transmission).

Another implementation may regard an aperiodic SRS. In such a scenario, from the first symbol carrying the SRS request DCI to the last symbol of the triggered SRS resource set, the UE may not expect to receive an SFI indication, uplink cancellation indication, or a dynamic scheduling of downlink channel/signal(s) on flexible symbol(s) that may change the determination of available slot. An implementation may combine the above options.

In an example where X=1, the UE may transmit 5 frequency hops, each one starting at the symbol-index of a corresponding available slot, for 5 slots back-to-back, starting from the available slot with id equals to slot-index. To determine whether a frequency hop can fit in the available symbols of a slot, a first rule may include using a consecutive set of OFDM symbols in a slot that are uplink or flexible symbols. Another rule may configure a frequency hop to be as many symbols as the basic pattern given by the nrofSymbols-r16. Another illustrative rule may for each frequency hop, count Y number of symbols at 912 before and after the SRS. This rule may apply unless the frequency hop is within an active BWP. In such a scenario, there is no need of a retune time before or after.

Another illustrative rule may determine at 914 if a frequency hop positioned together with any retune could be confined within a given slot. If not, then the potential position may not be considered available, and the UE may perform the frequency hop in a next available opportunity. Another rule and associated operation at 910 may determine a retune time satisfies an UE capability regarding a minimum timing requirement for an aperiodic sounding reference signal transmission. This may ensure the satisfaction of UE capability on a minimum timing requirement between triggering PDCCH and all the SRS resources in the resource set (e.g., assuming an aperiodic SRS transmission).

An option consistent with an implementation of the method 900 may be based in part on RRC impact and an explicit configuration of the starting symbol index. The UE may format multiple tuples (e.g., starting symbol-idx, slot-idx), such that each one corresponds to a different frequency hop. Specifically, the starting symbol (e.g., starting symbol-idx) and the starting slot offset (e.g., slot-idx) are specified for SRS resource with tx frequency hopping for different resource types (aperiodic, semi-persistent or periodic SRS transmission). In some embodiments, each corresponding hop may be configured with the same periodicity. Another implementation at 916 may configure multiple (e.g., starting Symbol-idx) tuples, each one for a given frequency hop. The scenario may assume that the i-th frequency hop may be transmitted in a same slot as the previous one should the frequency hop opportunity start at the corresponding {symbol-idx}. If unavailable, the frequency hop may otherwise be transmitted in a next slot at the next available frequency hop opportunity starting at the {symbol-dx}, and so on. Another option may reuse an already existing single {Symbol-idx, slot-idx} in a configuration and have implicit rules of how these are being interpreted.

Where an uplink transmission window is configured, the UE may perform consecutive frequency hops until all the frequency hops are finished inside the window. This scenario may be accomplished without regard for slot boundaries. The first frequency hop may be transmitted in the {Symbol-idx, slot-idx}, and the rest may continue at 918 to search for a next available opportunity after previously determining an absence of an opportunity. For example, the rest frequency hops may continue to be transmitted independent of the slot boundaries. In other implementation, the symbols belonging in a frequency hop may still be part of one of the slots. Available symbols may include uplink, flexible symbols, or downlink symbols within the uplink transmission window.

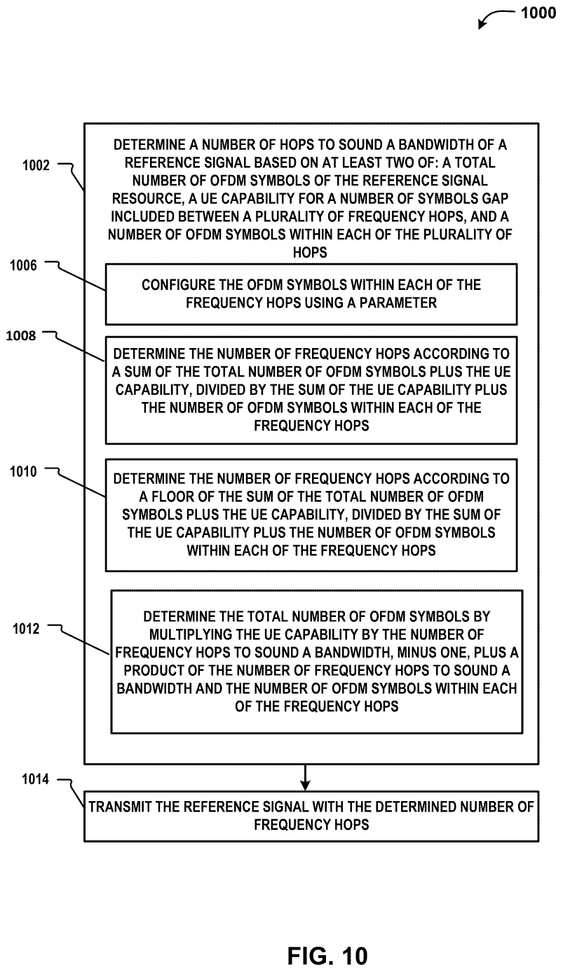

FIG. 10 is a flow diagram of a method 1000 of determining a number of frequency hops to be included in a reference signal, according to an embodiment. Means for performing the functionality illustrated in one or more of the blocks shown in FIG. 10 may be performed by hardware and/or software components to determine a number of frequency hops to be included in an SRS. Example components of an illustrative apparatus (e.g., a UE) are illustrated in FIG. 12, which is described in more detail below.

Turning more particularly to the flow diagram, the method 1000 may determine at block 1002 a number of frequency hops to sound a bandwidth of a reference signal based on at least two of: a total number of orthogonal frequency division multiplexing (OFDM) symbols of the SRS resource, a UE capability for a number of symbols gap included between a plurality of frequency hops, and a number of OFDM symbols within each of the plurality of frequency hops.

Means for performing functionality at block 1002 may comprise bus 1205, processor(s) 1210, wireless communication interface 1230, memory 1260, and/or other components of a UE, such as those as illustrated in FIG. 12 and described hereafter.

At block 1014, the method 1000 may transmit the SRS with the determined number of frequency hops.

Means for performing functionality at block 1014 may comprise bus 1205, processor(s) 1210, wireless communication interface 1230, memory 1260, and/or other components of a UE, such as those as illustrated in FIG. 12 and described hereafter.

An implementation of the method 1000 may at 1006 configure the OFDM symbols within each of the frequency hops using a parameter.

An implementation of the method 1000 may at 1008 determine the number of frequency hops according to a sum of the total number of OFDM symbols plus the UE capability, divided by the sum of the UE capability plus the number of OFDM symbols within each of the frequency hops. The particular implementation may use the following formula:

$${N}_{h} equals : {N}_{h} = \frac{{N}_{s} + X}{X + R} .$$

In the illustrative formula, Nₕ may equal a number of frequency hops needed to sound a total bandwidth. X may be a UE capability for the number of symbols gap needed between frequency hops. Nₛ may be a configured total number of symbols of an SRS resource (nrofSymbols) in a slot. This configuration already exists in RRC. R may be a number of OFDM symbols within each frequency hop, configured at 1006 through a parameter, such as a repetition Factor. X, Nₛ, and R should be positive non-zero integers that result to a non-zero integer value for Nₕ according to the formula.

An implementation of the method 1000 may at 1010 determine the number of frequency hops according to a floor of the sum of the total number of OFDM symbols plus the UE capability, divided by the sum of the UE capability plus the number of OFDM symbols within each of the frequency hops. According to another illustrative formula at 1010,

$${N}_{h} = floor ( \frac{{N}_{s} + X}{X + R} ) .$$

An implementation of the method 1000 may at 1012 determine the total number of OFDM symbols by multiplying the UE capability by the number of frequency hops to sound a bandwidth, minus one, plus a product of the number of frequency hops to sound a bandwidth and the number of OFDM symbols within each of the frequency hops. For example, the system may determine the configured total number of symbols of an SRS resource in a slot according to: (Nₕ−1)·X+Nₕ·R=Nₛ.

In the foregoing, X may comprise a UE capability for the number of symbols gap needed between frequency hops, and R may comprise a number of OFDM symbols within each frequency hop, configured through a parameter.

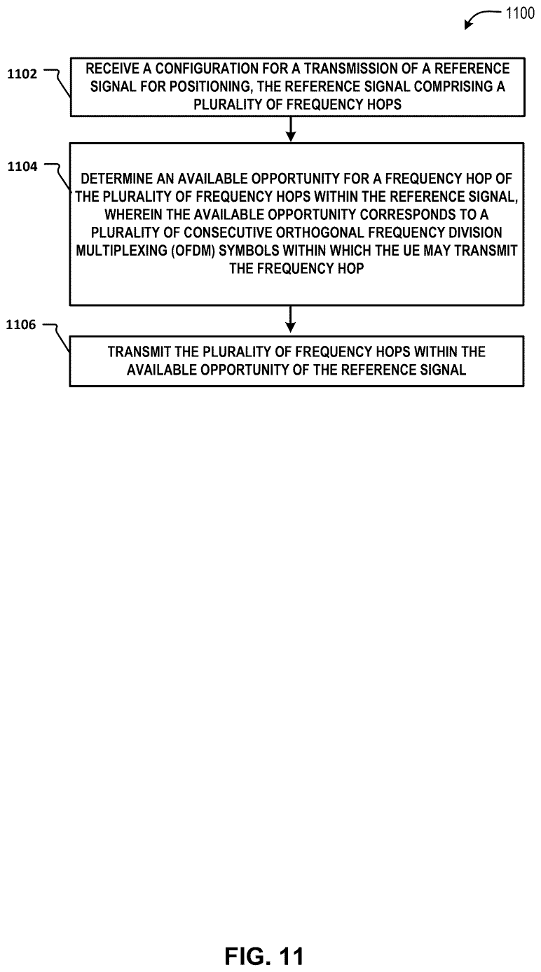

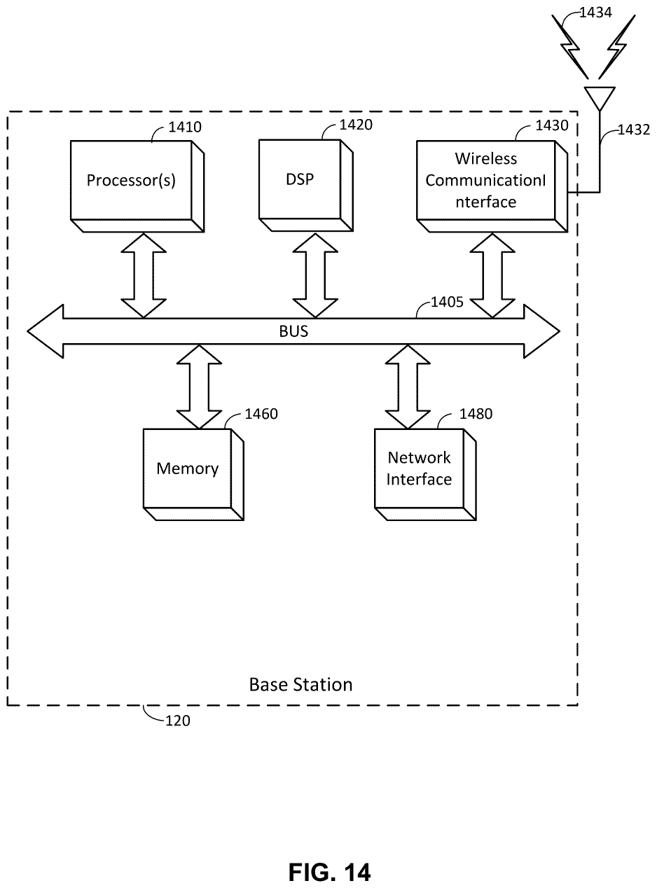

FIG. 11 is a flow diagram of a method 1100 of determining an available opportunity for the transmission of the plurality of frequency hops, according to an embodiment. Means for performing the functionality illustrated in one or more of the blocks shown in FIG. 11 may be performed by hardware and/or software components to determine an available opportunity for the transmission of the plurality of frequency hops. Example components of an illustrative apparatus (e.g., a base station) are illustrated in FIG. 14, which is described in more detail below.

An implementation of the method 1100 may use time domain transmission properties of an SRS resource for positioning frequency hops within intra-slot and back-to-back slot scenarios. An illustrative implementation may include configuring UEs (e.g., including reduced capability (redcap) UEs).

As described in more detail herein, the method 1100 may include a base station determining, at block 1102, a configuration for a transmission of a reference signal for positioning. The reference signal may comprise a plurality of frequency hops.

Means for performing functionality at block 1102 may comprise bus 1405, processor(s) 1410, wireless communication interface 1430, memory 1460, and/or other components of a base station, such as those as illustrated in FIG. 14 and described hereafter.

When determining the configuration, at block 1104, the base station may determine an available opportunity for a frequency hop of the plurality of frequency hops within the reference signal based on considering that the frequency hop and a retune time are confined within a slot. Available opportunities may correspond to a collection of consecutive OFDM symbols within which the UE may transmit one frequency hop of an RS according to some rules.

Means for performing functionality at block 1104 may comprise bus 1405, processor(s) 1410, wireless communication interface 1430, memory 1460, and/or other components of a base station, such as those as illustrated in FIG. 14 and described hereafter.

At block 1106, the base station may send the configuration to the UE for performing the transmission of the reference signal in accordance with the configuration.

Means for performing functionality at block 1106 may comprise bus 1405, processor(s) 1410, wireless communication interface 1430, memory 1460, one or more wireless communication antenna(s) 1432, and/or other components of a base station, such as those as illustrated in FIG. 14 and described hereafter.

In some embodiments, the available opportunity is further determined based on a capability of the UE regarding the retune time.

In some embodiments, the capability indicates that the retune time satisfies a capability of the UE regarding a minimum timing requirement between transmissions of the reference signal.

In some embodiments, the available opportunity is further determined based on the retune time between a bandwidth part (BWP) and a frequency hop.

In some embodiments, reference signal includes one of a sounding reference signal (SRS) or a sidelink positioning reference signal (SL-PRS).

In some embodiments, the configuration has multiple tuples including a format comprising a starting symbol index and a slot index for SRS resource with frequency hopping for different resource types, wherein each of the multiple tuples corresponds to one of the plurality of frequency hops.

In some embodiments, each corresponding frequency hop is configured with a same periodicity.

In some embodiments, determining the configuration may further comprise determining a number of the plurality of frequency hops based on at least two of: a total number of OFDM symbols, a UE capability for a number of symbols gap included between a plurality of frequency hops, and a number of OFDM symbols within each of the plurality of frequency hops.

FIG. 12 is a block diagram of an embodiment of a UE 105, which can be utilized as described herein above. For example, the UE 105 can perform one or more of the functions of the method shown in FIGS. 9 and 10. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 1.

The UE 105 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The UE 105 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 105 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques with respective digital and/or analog circuitry. The wireless communication interface 1230 may include such circuitry.

Depending on desired functionality, the wireless communication interface 1230 may comprise a separate receiver and transmitter or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1210 or DSP 1220.

The UE 105 may further include and/or be in communication with a memory 1260. The memory 1260 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 105 also can comprise software elements (not shown in FIG. 1), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 105 (and/or processor(s) 1210 or DSP 1220 within UE 105). In some embodiments, then, such code and/or instructions can be used to configure and/or adapt a general-purpose computer (or other device) to perform one or more operations in accordance with the described methods.

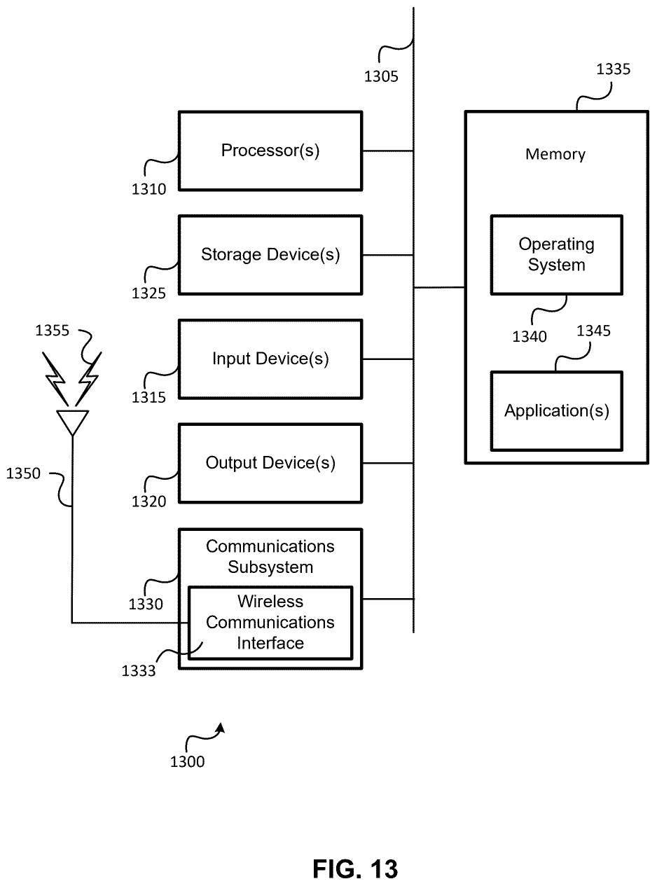

FIG. 13 is a block diagram of an embodiment of a computer system 1300, which may be used, in whole or in part, to provide the functions of one or more network components as described in the embodiments herein. It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner. In addition, it can be noted that components illustrated by FIG. 13 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processor(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1315, which may comprise without limitation a mouse, a keyboard, a camera, a microphone, and/or the like; and one or more output devices 1320, which may comprise without limitation a display device, a printer, and/or the like.

The computer system 1300 may further include (and/or be in communication with) one or more non-transitory storage devices 1325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may comprise wireless communication technologies managed and controlled by a wireless communication interface 1333, as well as wired technologies (such as Ethernet, coaxial communications, universal serial bus (USB), and the like). The wireless communication interface 1333 may comprise one or more wireless transceivers that may send and receive wireless signals 1355 (e.g., signals according to 5G NR or LTE) via wireless antenna(s) 1350. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network, including a User Equipment (UE), base stations and/or other TRPs, and/or any other electronic devices described herein. Hence, the communications subsystem 1330 may be used to receive and send data as described in the embodiments herein.

In many embodiments, the computer system 1300 will further comprise a working memory 1335, which may comprise a RAM or ROM device, as described above. Software elements, shown as being located within the working memory 1335, may comprise an operating system 1340, device drivers, executable libraries, and/or other code, such as one or more applications 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

FIG. 14 is a block diagram of an embodiment of a base station 120, which can be utilized as described herein above (e.g., in association with a base station 120 in FIG. 1, a gNB 210 in FIG. 2, a base station 310 in FIG. 3, and/or the base station performing functions in FIG. 11). It should be noted that FIG. 14 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1405 (or may otherwise be in communication, as appropriate). The hardware elements may include a processor(s) 1410 which can include without limitation one or more general-purpose processors, one or more special-purpose processors (such as DSP chips, graphics acceleration processors, ASICs, and/or the like), and/or other processing structure or means. As shown in FIG. 14, some embodiments may have a separate DSP 1420, depending on desired functionality. Location determination and/or other determinations based on wireless communication may be provided in the processor(s) 1410 and/or wireless communication interface 1430 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 may also include a wireless communication interface 1430, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1430 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1432 that send and/or receive wireless signals 1434.

The base station 120 may also include a network interface 1480, which can include support of wireline communication technologies. The network interface 1480 may include a modem, network card, chipset, and/or the like. The network interface 1480 may include one or more input and/or output communication interfaces to permit data to be exchanged with a network, communication network servers, computer systems, and/or any other electronic devices described herein.

In many embodiments, the base station 120 may further comprise a memory 1460. The memory 1460 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1460 of the base station 120 also may comprise software elements (not shown in FIG. 14), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1460 that are executable by the base station 120 (and/or processor(s) 1410 or DSP 1420 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. An apparatus for wireless communication by user equipment (UE), the apparatus comprising: one or more transceivers; one or more memories; and one or more processors communicatively coupled with the one or more transceivers and the one or more memories, wherein the one or more processors are configured to: receive a configuration for a transmission of a reference signal for positioning, the reference signal comprising a plurality of frequency hops; determine an available opportunity for a frequency hop of the plurality of frequency hops within the reference signal, wherein the available opportunity corresponds to a plurality of consecutive orthogonal frequency division multiplexing (OFDM) symbols within which the UE can [transmit the frequency hop; and transmit the plurality of frequency hops within the available opportunity of the reference signal.
Clause 2. The apparatus of clause 1, wherein the one or more processors are further configured to determine the available opportunity by transmitting one frequency hop of the plurality of frequency hops in each of a plurality of back-to-back OFDM slots of the reference signal.
Clause 3. The apparatus of clause 1 or 2, wherein the reference signal includes one of a sounding reference signal (SRS) or a sidelink positioning reference signal (SL-PRS).
Clause 4. The apparatus of clauses 1-3, wherein the one or more processors are further configured to determine the available opportunity by taking into account a retune time between a bandwidth part (BWP) and a frequency hop.
Clause 5. The apparatus of clauses 1-4, wherein the one or more processors are further configured to determine the available opportunity by counting a number of symbols if successive frequency hops are not in the same BWP to determine whether there is sufficient retune time.
Clause 6. The apparatus of clauses 1-5, wherein the one or more processors are further configured to determine the available opportunity by determining the frequency hop and a retune time are confined within a slot.
Clause 7. The apparatus of clauses 1-6, wherein the configuration has multiple tuples including a format comprising a starting symbol index and a slot index for SRS resource with frequency hopping for different resource types, wherein each of the multiple tuples corresponds to one of the plurality of frequency hops.
Clause 8. The apparatus of clauses 1-7, wherein each corresponding frequency hop is configured with a same periodicity.
Clause 9. The apparatus of clauses 1-8, wherein the one or more processors are further configured to determine a number of the plurality of frequency hops based on at least two of: a total number of OFDM symbols, a UE capability for a number of time-domain gap included between a plurality of frequency hops, and a number of OFDM symbols within each of the plurality of frequency hops.
Clause 10. The apparatus of clauses 1-9, wherein the number of OFDM symbols within each of the frequency hops is configured through a parameter.
Clause 11. An apparatus for wireless communication by user equipment (UE), the apparatus comprising: one or more transceivers; one or more memories; and one or more processors communicatively coupled with the one or more transceivers and the one or more memories, wherein the one or more processors are configured to: determine a number of frequency hops to sound a bandwidth of a reference signal based on at least two of: a total number of orthogonal frequency division multiplexing (OFDM) symbols of a reference signal resource, a UE capability for a number of symbols gap included between a plurality of frequency hops, and a number of OFDM symbols within each of the plurality of frequency hops; and transmit the reference signal with the determined number of frequency hops.
Clause 12. The apparatus of clause 11, wherein the number of OFDM symbols within each of the frequency hops is configured through a parameter.
Clause 13. The apparatus of clause 11 or 12, wherein the one or more processors are further configured to determine the number of frequency hops according to a sum of the total number of OFDM symbols plus the UE capability, divided by the sum of the UE capability plus the number of OFDM symbols within each of the frequency hops.
Clause 14. The apparatus of clauses 11-13, wherein the one or more processors are further configured to determine the number of frequency hops according to a floor of a sum of the total number of OFDM symbols plus the UE capability, divided by the sum of the UE capability plus the number of OFDM symbols within each of the frequency hops.
Clause 15. The apparatus of clauses 11-14, wherein the one or more processors are further configured to determine the total number of OFDM symbols by multiplying the UE capability by the number of frequency hops to sound a bandwidth, minus one, plus a product of the number of frequency hops to sound a bandwidth and the number of OFDM symbols within each of the frequency hops.
Clause 16. A base station for wireless communication by user equipment (UE), comprising: one or more transceivers; one or more memories; and one or more processors communicatively coupled with the one or more transceivers and the one or more memories, wherein the one or more processors are configured to: determine a configuration for a transmission of a reference signal for positioning, the reference signal comprising a plurality of frequency hops, wherein determining the configuration comprises: determine an available opportunity for a frequency hop of the plurality of frequency hops within the reference signal based on considering that the frequency hop and a retune time are confined within a slot, wherein the available opportunity corresponds to a plurality of consecutive orthogonal frequency division multiplexing (OFDM) symbols within which the UE may transmit the frequency hop; and send, to the UE, the configuration for performing the transmission of the reference signal in accordance with the configuration.
Clause 17. The base station of clause 16, wherein the available opportunity is further determined based on a capability of the UE regarding the retune time.
Clause 18. The base station of clause 16 or 17, wherein the capability indicates that the retune time satisfies a capability of the UE regarding a minimum timing requirement between transmissions of the reference signal.
Clause 19. The base station of clauses 16-18, wherein the available opportunity is further determined based on the retune time between a bandwidth part (BWP) and a frequency hop.
Clause 20. The base station of clauses 16-19, wherein the reference signal includes one of a sounding reference signal (SRS) or a sidelink positioning reference signal (SL-PRS).
Clause 21. The base station of clauses 16-20, wherein the configuration has multiple tuples including a format comprising a starting symbol index and a slot index for SRS resource with frequency hopping for different resource types, wherein each of the multiple tuples corresponds to one of the plurality of frequency hops.
Clause 22. The base station of clauses 16-21, wherein each corresponding frequency hop is configured with a same periodicity.
Clause 23. The base station of clauses 16-22, wherein the one or more processors are further configured to: determine a number of the plurality of frequency hops based on at least two of: a total number of OFDM symbols, a UE capability for a number of symbols gap included between a plurality of frequency hops, and a number of OFDM symbols within each of the plurality of frequency hops.
Clause 24. A method of configuring a reference signal transmission, the method comprising: receiving at user equipment (UE) a configuration for a transmission of a reference signal for positioning, the reference signal comprising a plurality of frequency hops; determining an available opportunity for a frequency hop of the plurality of frequency hops within the reference signal, wherein the available opportunity corresponds to a plurality of consecutive orthogonal frequency division multiplexing (OFDM) symbols within which the UE may transmit the frequency hop; and transmitting the plurality of frequency hops within the available opportunity of the reference signal.
Clause 25. The method of clause 24, further comprising determining that a retune time satisfies a UE capability regarding a minimum timing requirement between transmissions of the reference signal.
Clause 26. The method of clause 24 or 25, wherein the reference signal includes one of a sounding reference signal (SRS) or a sidelink positioning reference signal (SL-PRS).
Clause 27. The method of clauses 24-26, further comprising determining the available opportunity by taking into account a retune time between a bandwidth part (BWP) and a frequency hop.
Clause 28. The method of clauses 24-27, further comprising determining the available opportunity by counting a number of symbols if successive frequency hops are not in the same BWP to determine whether there is sufficient retune time.
Clause 29. The method of clauses 24-28, further comprising determining the available opportunity by determining the frequency hop and a retune time are confined within a slot.
Clause 30. The method of clauses 24-29, wherein the configuration has multiple tuples including a format comprising a starting symbol index and a slot index for SRS resource with frequency hopping for different resource types, wherein each of the multiple tuples corresponds to one of the plurality of frequency hops.
Clause 31. The method of clauses 24-30, wherein each corresponding frequency hop is configured with a same periodicity.
Clause 32. The method of clauses 24-31, further comprising determining a number of the plurality of frequency hops based on at least two of: a total number of OFDM symbols, a UE capability for a number of time-domain gap included between a plurality of frequency hops, and a number of OFDM symbols within each of the plurality of frequency hops.
Clause 33. The method of clauses 24-32, wherein the number of OFDM symbols within each of the frequency hops is configured through a parameter.
Clause 34. A method of configuring a reference signal transmission, the method comprising: determining a number of frequency hops to sound a bandwidth of a reference signal based on at least two of: a total number of orthogonal frequency division multiplexing (OFDM) symbols of a reference signal resource, a UE capability for a number of symbols gap included between a plurality of frequency hops, and a number of OFDM symbols within each of the plurality of frequency hops; and transmitting the reference signal with the determined number of frequency hops.
Clause 35. The method of clause 34, wherein the number of OFDM symbols within each of the frequency hops is configured through a parameter.
Clause 36. The method of clause 34 or 35, further comprising determining the number of frequency hops according to a sum of the total number of OFDM symbols plus the UE capability, divided by the sum of the UE capability plus the number of OFDM symbols within each of the frequency hops.
Clause 37. The method of clauses 34-36, further comprising determining the number of frequency hops according to a floor of a sum of the total number of OFDM symbols plus the UE capability, divided by the sum of the UE capability plus the number of OFDM symbols within each of the frequency hops.
Clause 38. The method of clauses 34-36, further comprising determining the total number of OFDM symbols by multiplying the UE capability by the number of frequency hops to sound a bandwidth, minus one, plus a product of the number of frequency hops to sound a bandwidth and the number of OFDM symbols within each of the frequency hops.
Clause 39. A method for wireless communication comprising: determining a configuration for a transmission of a reference signal for positioning, the reference signal comprising a plurality of frequency hops, wherein determining the configuration comprises determining an available opportunity for a frequency hop of the plurality of frequency hops within the reference signal based on considering that the frequency hop and a retune time are confined within a slot, wherein the available opportunity corresponds to a plurality of consecutive orthogonal frequency division multiplexing (OFDM) symbols within which the UE may transmit the frequency hop; and sending, to the UE, the configuration for performing the transmission of the reference signal in accordance with the configuration.
Clause 40. The method of clause 39, wherein the available opportunity is further determined based on a capability of the UE regarding the retune time.
Clause 41. The method of clause 39 or 40, wherein the capability indicates that the retune time satisfies a capability of the UE regarding a minimum timing requirement between transmissions of the reference signal.
Clause 42. The method of clauses 39-41, wherein the available opportunity is further determined based on the retune time between a bandwidth part (BWP) and a frequency hop.
Clause 43. The method of clauses 39-42, wherein the reference signal includes one of a sounding reference signal (SRS) or a sidelink positioning reference signal (SL-PRS).
Clause 44. The method of clauses 39-43, wherein the configuration has multiple tuples including a format comprising a starting symbol index and a slot index for SRS resource with frequency hopping for different resource types, wherein each of the multiple tuples corresponds to one of the plurality of frequency hops.
Clause 45. The method of clauses 39-44, wherein each corresponding frequency hop is configured with a same periodicity.
Clause 46. The method of clauses 39-45, further comprising: determining a number of the plurality of frequency hops based on at least two of: a total number of OFDM symbols, a UE capability for a number of symbols gap included between a plurality of frequency hops, and a number of OFDM symbols within each of the plurality of frequency hops.
Clause 47. An apparatus for configuring a reference signal transmission, the apparatus comprising: means for receiving at user equipment (UE) a configuration for a transmission of a reference signal for positioning, the reference signal comprising a plurality of frequency hops; means for determining an available opportunity for a frequency hop of the plurality of frequency hops within the reference signal, wherein the available opportunity corresponds to a plurality of consecutive orthogonal frequency division multiplexing (OFDM) symbols within which the UE may transmit the frequency hop; and means for transmitting the plurality of frequency hops within the available opportunity of the reference signal.
Clause 48. The apparatus of clause 47, the apparatus further comprising: means for determining that a retune time satisfies a UE capability regarding a minimum timing requirement between transmissions of the reference signal.
Clause 49. The apparatus of clause 47 or 48 wherein the reference signal includes one of a sounding reference signal (SRS) or a sidelink positioning reference signal (SL-PRS).
Clause 50. The apparatus of clauses 47-49, further comprising: means for determining the available opportunity by taking into account a retune time between a bandwidth part (BWP) and a frequency hop.
Clause 51. The apparatus of clauses 47-50, further comprising: means for determining the available opportunity by counting a number of symbols if successive frequency hops are not in the same BWP to determine whether there is sufficient retune time.
Clause 52. The apparatus of clauses 47-51, further comprising: means for determining the available opportunity by determining the frequency hop and a retune time are confined within a slot.
Clause 53. The apparatus of clauses 47-52, wherein the configuration has multiple tuples including a format comprising a starting symbol index and a slot index for SRS resource with frequency hopping for different resource types, wherein each of the multiple tuples corresponds to one of the plurality of frequency hops.
Clause 54. The apparatus of clauses 47-53, wherein each corresponding frequency hop is configured with a same periodicity.
Clause 55. The apparatus of clauses 47-54, further comprising: means for determining a number of the plurality of frequency hops based on at least two of: a total number of OFDM symbols, a UE capability for a number of time-domain gap included between a plurality of frequency hops, and a number of OFDM symbols within each of the plurality of frequency hops.
Clause 56. The apparatus of clauses 47-55, wherein the number of OFDM symbols within each of the frequency hops is configured through a parameter.
Clause 57. An apparatus for configuring a reference signal transmission, the apparatus comprising: means for determining a number of frequency hops to sound a bandwidth of a reference signal based on at least two of: a total number of orthogonal frequency division multiplexing (OFDM) symbols of a reference signal resource, a UE capability for a number of symbols gap included between a plurality of frequency hops, and a number of OFDM symbols within each of the plurality of frequency hops; and means for transmitting the reference signal with the determined number of frequency hops.
Clause 58. The apparatus of clause 57, wherein the number of OFDM symbols within each of the frequency hops is configured through a parameter.
Clause 59. The apparatus of clause 57 or 58, further comprising: means for determining the number of frequency hops according to a sum of the total number of OFDM symbols plus the UE capability, divided by the sum of the UE capability plus the number of OFDM symbols within each of the frequency hops.
Clause 60. The apparatus of clauses 57-59, further comprising: means for determining the number of frequency hops according to a floor of a sum of the total number of OFDM symbols plus the UE capability, divided by the sum of the UE capability plus the number of OFDM symbols within each of the frequency hops.
Clause 61. The apparatus of clauses 57-60, further comprising: means for determining the total number of OFDM symbols by multiplying the UE capability by the number of frequency hops to sound a bandwidth, minus one, plus a product of the number of frequency hops to sound a bandwidth and the number of OFDM symbols within each of the frequency hops.
Clause 62. An apparatus for wireless communication comprising: means for determining a configuration for a transmission of a reference signal for positioning, the reference signal comprising a plurality of frequency hops, wherein determining the configuration comprises determining an available opportunity for a frequency hop of the plurality of frequency hops within the reference signal based on considering that the frequency hop and a retune time are confined within a slot, wherein the available opportunity corresponds to a plurality of consecutive orthogonal frequency division multiplexing (OFDM) symbols within which the UE may transmit the frequency hop; and means for sending, to the UE, the configuration for performing the transmission of the reference signal in accordance with the configuration.
Clause 63. The apparatus of clause 62, wherein the available opportunity is further determined based on a capability of the UE regarding the retune time.
Clause 64. The apparatus of clause 62 or 63, wherein the capability indicates that the retune time satisfies a capability of the UE regarding a minimum timing requirement between transmissions of the reference signal.
Clause 65. The apparatus of clauses 62-64, wherein the available opportunity is further determined based on the retune time between a bandwidth part (BWP) and a frequency hop.
Clause 66. The apparatus of clauses 62-65, wherein the reference signal includes one of a sounding reference signal (SRS) or a sidelink positioning reference signal (SL-PRS).
Clause 67. The apparatus of clauses 62-66, wherein the configuration has multiple tuples including a format comprising a starting symbol index and a slot index for SRS resource with frequency hopping for different resource types, wherein each of the multiple tuples corresponds to one of the plurality of frequency hops.
Clause 68. The apparatus of clauses 62-67, wherein each corresponding frequency hop is configured with a same periodicity.
Clause 69. The apparatus of clauses 62-6, further comprising: means for determining a number of the plurality of frequency hops based on at least two of: a total number of OFDM symbols, a UE capability for a number of symbols gap included between a plurality of frequency hops, and a number of OFDM symbols within each of the plurality of frequency hops.

1. An apparatus for wireless communication by user equipment (UE), the apparatus comprising:
one or more transceivers;
one or more memories; and
one or more processors communicatively coupled with the one or more transceivers and the one or more memories, wherein the one or more processors are configured to:
receive a configuration for a transmission of a reference signal for positioning, the reference signal comprising a plurality of frequency hops;
determine an available opportunity for a frequency hop of the plurality of frequency hops within the reference signal, wherein the available opportunity corresponds to a plurality of consecutive orthogonal frequency division multiplexing (OFDM) symbols within which the UE can transmit the frequency hop; and
transmit the plurality of frequency hops within the available opportunity of the reference signal.

2. The apparatus of claim 1, wherein the one or more processors are further configured to determine that a retune time satisfies a UE capability regarding a minimum timing requirement between transmissions of the reference signal.

3. The apparatus of claim 1, wherein the reference signal includes one of a sounding reference signal (SRS) or a sidelink positioning reference signal (SL-PRS).

4. The apparatus of claim 1, wherein the one or more processors are further configured to determine the available opportunity by taking into account a retune time between a bandwidth part (BWP) and a frequency hop.

5. The apparatus of claim 4, wherein the one or more processors are further configured to determine the available opportunity by counting a number of symbols if successive frequency hops are not in the same BWP to determine whether there is sufficient retune time.

6. The apparatus of claim 1, wherein the one or more processors are further configured to determine the available opportunity by determining the frequency hop and a retune time are confined within a slot.

7. The apparatus of claim 1, wherein the configuration has multiple tuples including a format comprising a starting symbol index and a slot index for SRS resource with frequency hopping for different resource types, wherein each of the multiple tuples corresponds to one of the plurality of frequency hops.

8. The apparatus of claim 7, wherein each corresponding frequency hop is configured with a same periodicity.

9. The apparatus of claim 1, wherein the one or more processors are further configured to determine a number of the plurality of frequency hops based on at least two of: a total number of OFDM symbols, a UE capability for a number of time-domain gap included between a plurality of frequency hops, and a number of OFDM symbols within each of the plurality of frequency hops.

10. The apparatus of claim 9, wherein the number of OFDM symbols within each of the frequency hops is configured through a parameter.

11. An apparatus for wireless communication by user equipment (UE), the apparatus comprising:
one or more transceivers;
one or more memories; and
one or more processors communicatively coupled with the one or more transceivers and the one or more memories, wherein the one or more processors are configured to:
determine a number of frequency hops to sound a bandwidth of a reference signal based on at least two of: a total number of orthogonal frequency division multiplexing (OFDM) symbols of a reference signal resource, a UE capability for a number of symbols gap included between a plurality of frequency hops, and a number of OFDM symbols within each of the plurality of frequency hops; and
transmit the reference signal with the determined number of frequency hops.

12. The apparatus of claim 11, wherein the number of OFDM symbols within each of the frequency hops is configured through a parameter.

13. The apparatus of claim 11, wherein the one or more processors are further configured to determine the number of frequency hops according to a sum of the total number of OFDM symbols plus the UE capability, divided by the sum of the UE capability plus the number of OFDM symbols within each of the frequency hops.

14. The apparatus of claim 11, wherein the one or more processors are further configured to determine the number of frequency hops according to a floor of a sum of the total number of OFDM symbols plus the UE capability, divided by the sum of the UE capability plus the number of OFDM symbols within each of the frequency hops.

15. The apparatus of claim 11, wherein the one or more processors are further configured to determine the total number of OFDM symbols by multiplying the UE capability by the number of frequency hops to sound a bandwidth, minus one, plus a product of the number of frequency hops to sound a bandwidth and the number of OFDM symbols within each of the frequency hops.

16. A base station for wireless communication by user equipment (UE), comprising:
one or more transceivers;
one or more memories; and
one or more processors communicatively coupled with the one or more transceivers and the one or more memories, wherein the one or more processors are configured to:
determine a configuration for a transmission of a reference signal for positioning, the reference signal comprising a plurality of frequency hops, wherein determining the configuration comprises:
determine an available opportunity for a frequency hop of the plurality of frequency hops within the reference signal based on considering that the frequency hop and a retune time are confined within a slot, wherein the available opportunity corresponds to a plurality of consecutive orthogonal frequency division multiplexing (OFDM) symbols within which the UE can transmit the frequency hop; and
send, to the UE, the configuration for performing the transmission of the reference signal in accordance with the configuration.

17. The base station of claim 16, wherein the available opportunity is further determined based on a capability of the UE regarding the retune time.

18. (canceled)

19. The base station of claim 16, wherein the available opportunity is further determined based on the retune time between a bandwidth part (BWP) and a frequency hop.

20. The base station of claim 16, wherein the reference signal includes one of a sounding reference signal (SRS) or a sidelink positioning reference signal (SL-PRS).

21. (canceled)

22. (canceled)

23. The base station of claim 16, wherein to determine the configuration, the one or more processors are further configured to: determine a number of the plurality of frequency hops based on at least two of: a total number of OFDM symbols, a UE capability for a number of symbols gap included between a plurality of frequency hops, and a number of OFDM symbols within each of the plurality of frequency hops.

24-30. (canceled)
